(19) United States
(12) Patent Application Publication
(10) Pub. No.: US 2013/0340670 A1
(43) Pub. Date: Dec. 26, 2013

(54) Boundary Marker for Curb or Property

(71) Applicant: Keith Vogt, Truckee, CA (US)

(72) Inventor: Keith Vogt, Truckee, CA (US)

(21) Appl. No.: 13/531,454

(22) Filed: Jun. 22, 2012

(51) Int. Cl. G01D 21/00

(52) U.S. Cl. 116/209

(57) ABSTRACT

The present disclosure relates to vertical markers placed in the ground to show property boundaries so that snow-removing ploughs or other vehicles do not damage curbing, drain covers and other areas of property. This disclosure is a driveway and street marker with an elongate tube and a optional cantilevered extending arm that extends out over a curb or property boundary, marking property to prevent snow-removal ploughs from damaging curbing, drain covers or other areas.

### BACKGROUND

The present disclosure relates to vertical markers placed in the ground to show property boundaries so that snow-removing ploughs or other vehicles do not damage curbing, drain covers and other areas of property. Many types of location or boundary markers are used in golf courses or on sidewalks. They are poles stuck into the dirt, or socket-and-pole systems, or poles on spring supports that allow the poles to bend when hit, and then flex back into place. An example of a driveway marker is U.S. Pat. No. 4,926,785, disclosing a marker post system.

The present embodiment is a property-boundary marker for driveway or curb that comprises 1. a hollow, elongate tube to hold vertical elongated elements that indicate boundaries during snow removal; 2. an installer piece that screws the hollow tube into the ground; 3. an optional cantilevered extending arm. An advantage of this system acts as a curb marker during snow-removal and prevents damage to curbing, drain covers and other areas by clearly marking property boundaries, protecting the property from damage by snow ploughs or other vehicles.

It is an object of the present invention to provide an improved method of marking property at the curb or property limit so that snow ploughs or other vehicles do not damage or drive upon a property.

### BRIEF DESCRIPTION

The present disclosure relates to vertical markers placed in the ground to demarcate property boundaries so that snow-removing ploughs or other vehicles do not damage curbing, drain covers and other areas of property. The disclosure illustrated is a driveway or curb marker with a hollow, elongate insert, an elongate installer, and an optional cantilevered extending arm. These parts make up a system for marking property so that snow-removal ploughs do not damage curbing, drain covers or other areas.

As understood by one skilled in the art, the formal principles of the present disclosure are not restricted to a specific property marker and may apply to any property markers of similar structure. For the purpose of clarity a given example property-marker device is shown and described.

These and other non-limiting features or characteristics of the present disclosure will be further described below.

### BRIEF DESCRIPTION OF THE DRAWINGS

The following is a brief description of the drawings, which are presented for the purposes of illustrating the disclosure set forth herein and not for the purposes of limiting the same.

FIG. 1 is a front perspective view of the present disclosure in its installed state with a pole inserted.

FIG. 2 is an exploded view of the embodiment with installing rod and cap.

FIG. 3 is a detail view of the elongate tube and its cap.

FIG. 4 is a front perspective view of the installing rod.

FIG. 5 shows the installing rod, cap, elongate tube, and two detailed views showing the cap-installation mechanism.

FIG. 6 is a perspective view of the installing rod, elongate tube, and an exploded view of the installing rod as it fits into the elongate tube.

FIG. 7 is a front perspective view of a second iteration of the embodiment.

FIG. 8 is an exploded view of the second iteration.

### DETAILED DESCRIPTION

A more complete understanding of the components, processes, and apparatus disclosed herein can be obtained by reference to the accompanying figures. These figures are intended to demonstrate the present disclosure and are not intended to show relative sizes and dimensions or to limit the scope of the disclosed embodiment(s). Although specific terms are used in the following description, these terms are intended to refer only to particular structures in the drawings and are not intended to limit the scope of the present disclosure. Like numeric designations refer to components of like function.

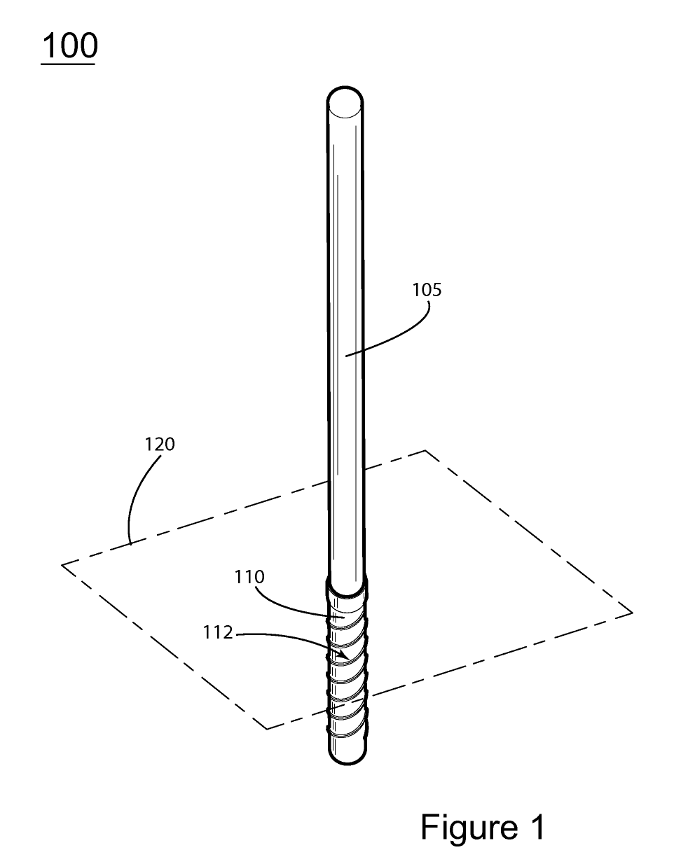

The embodiment is illustrated in FIGS. 1-8.

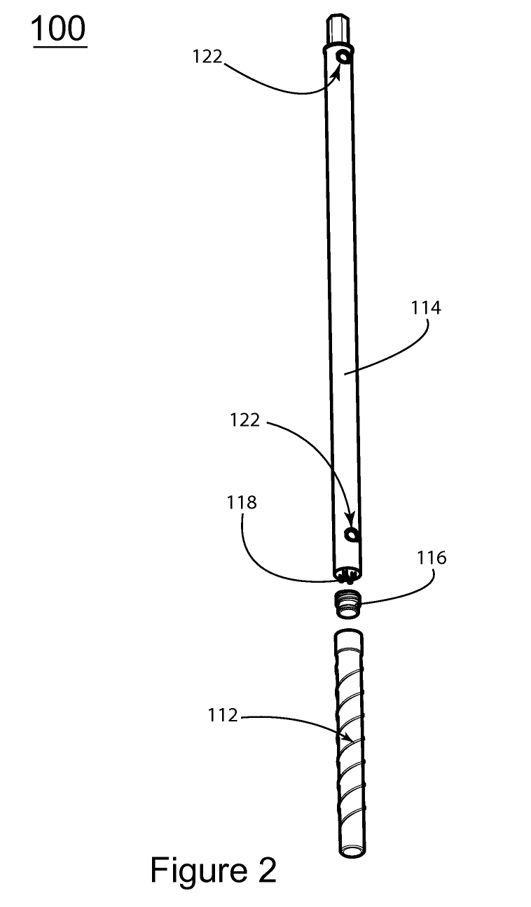

FIGS. 1 and 2: An object of the present disclosure 100 is a property marker with an elongate tube 110 that has screw-threads 112 and an installing rod 114. FIG. 1 shows the embodiment 100 in its installed state: the elongate tube 110 is screwed or forced into the ground, represented by ground plane 120, leaving the tube to receive a marker, such as a pole 105. FIG. 2 is an exploded view of the embodiment showing the elongate tube 110 which receives a cap 116 when the elongate tube is not in use. The cap is inserted and screwed into the elongate tube 110 via the installing rod 114, which has at one end 2 or more protrusions 118 that fit into the corresponding sockets (not shown) in the top of the cap 116. The protrusion-and-socket combination allows the installing-rod-end protrusions 118 to grip the cap while the installing rod is rotated, screwing the cap onto the top of the elongate tube 110. The elongate tube has screw-threads 112 that assist in turning it into the ground. The installing rod has at least two holes 122 that provide a means of inserting a torquing implement such as a screwdriver to assist in turning the installing rod 114.

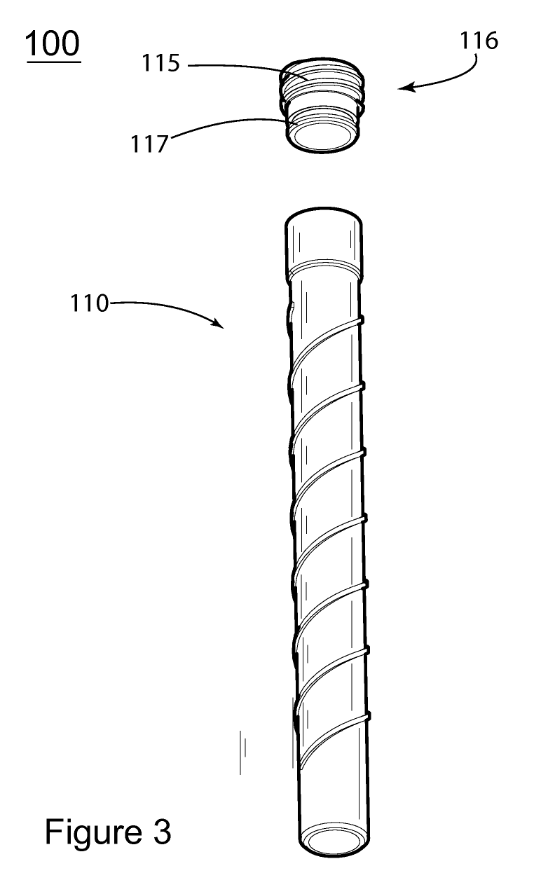

FIG. 3 is a detailed, exploded view of the cap 116 and elongate tube 110. The cap has threads 115 that engage with the elongate tube 110 and at least one gasket 117 providing a fluid-tight seal when engaged with the elongate tube 110.

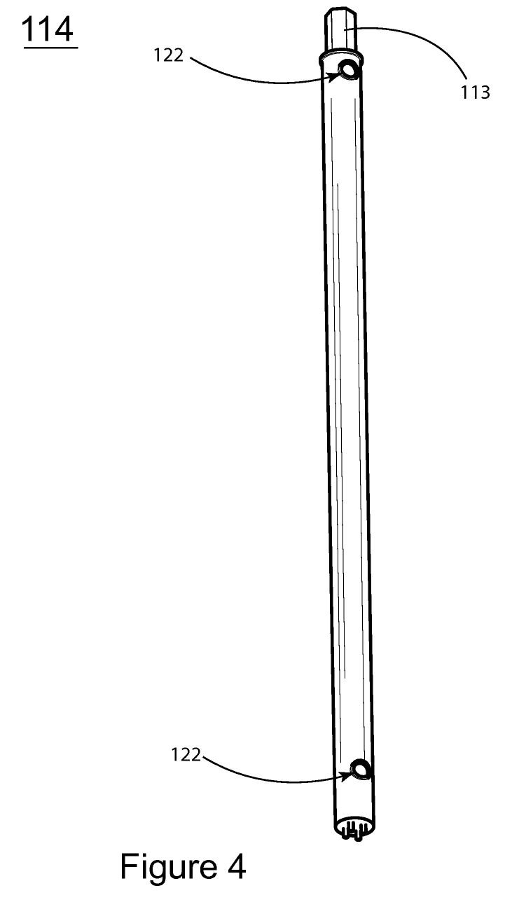

FIG. 4 shows the installing rod 114 including a faceted end 113 and the end used for installing the cap, with at least two protrusions 118, further including at least one hole 122 into which a torquing instrument can be inserted to assist in turning the installing rod.

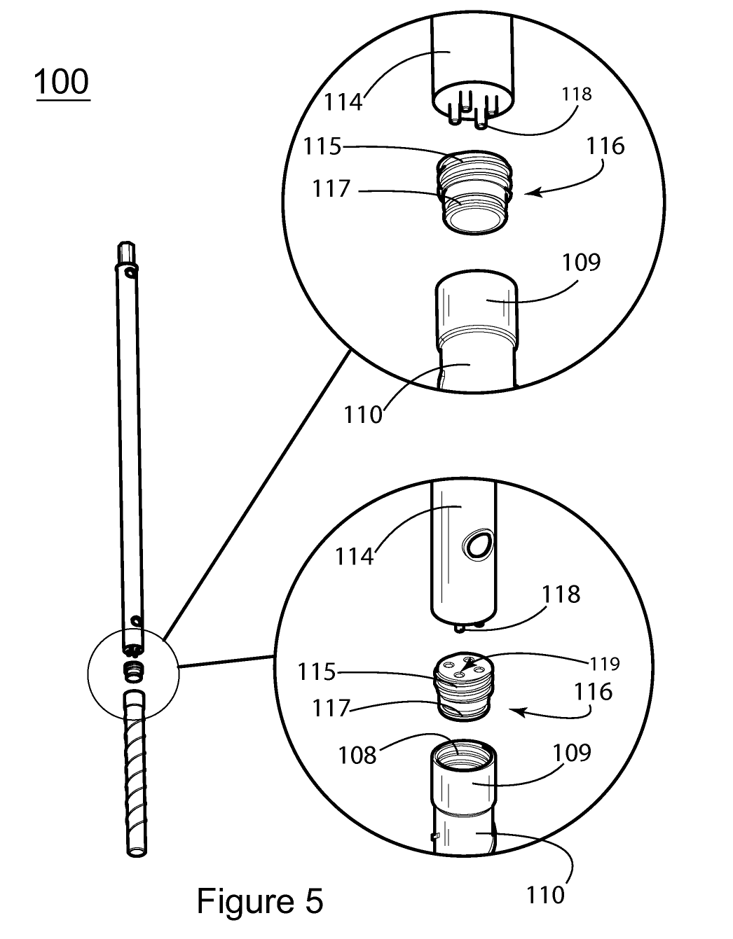

FIG. 5 is an exploded view of the embodiment 100 illustrating the mechanism of the installing rod 114. The installing rod's protrusions 118 can be inserted into the corresponding sockets 119 in the top of the cap 116 and turned so that the cap is secured into the elongate tube 110. This is done when the elongate tube is not in use, so that water and debris do not enter it. Threads 115 and a gasket 117 in the cap 116 allow the cap to be screwed into the corresponding threads 108 in the collet 109 of the elongate tube 110.

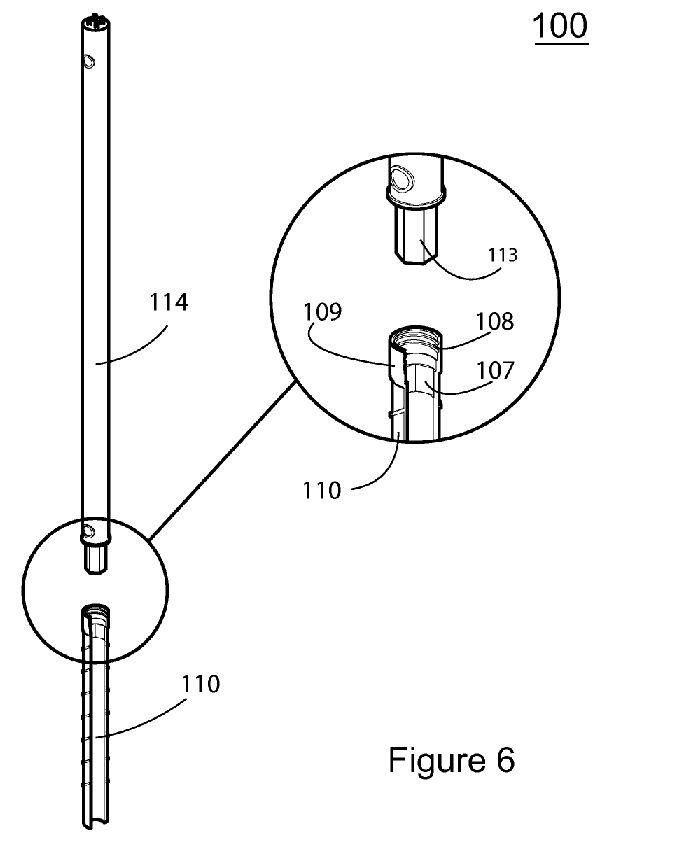

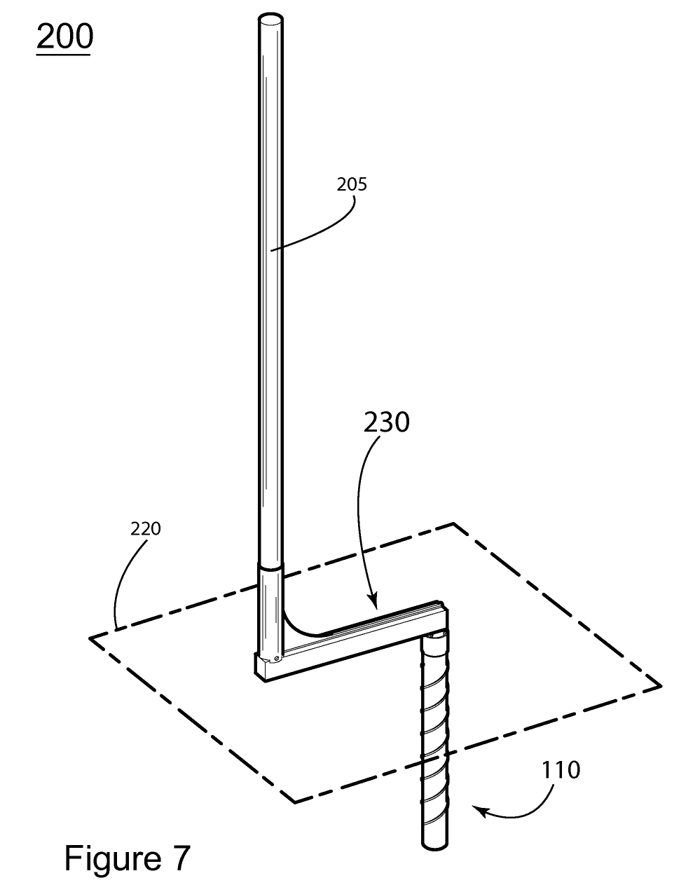

FIG. 6 shows the installing rod with one end having a faceted protuberance 113 that slides past the elongate tube's inner threads 108 and fits into the inner faceted opening 107 of the elongate tube 110. Once joined, the installing-rod-elongate-tube combination can be manually screwed into the ground or into a pre-drilled hole in the ground. Then the installing rod 114 is removed, leaving the elongate tube 110 in the ground. The installed tube acts as a receptacle for any pole, or for the optional extender 200, FIG. 7.

FIG. 7 shows a second iteration of the embodiment, which employs a pivoting, cantilevered extending arm 230 which can be optionally placed in the elongate tube 110 which is installed in the ground 220. An optional pole 205 (not part of this embodiment) can be placed in the cantilevered extending arm 230.

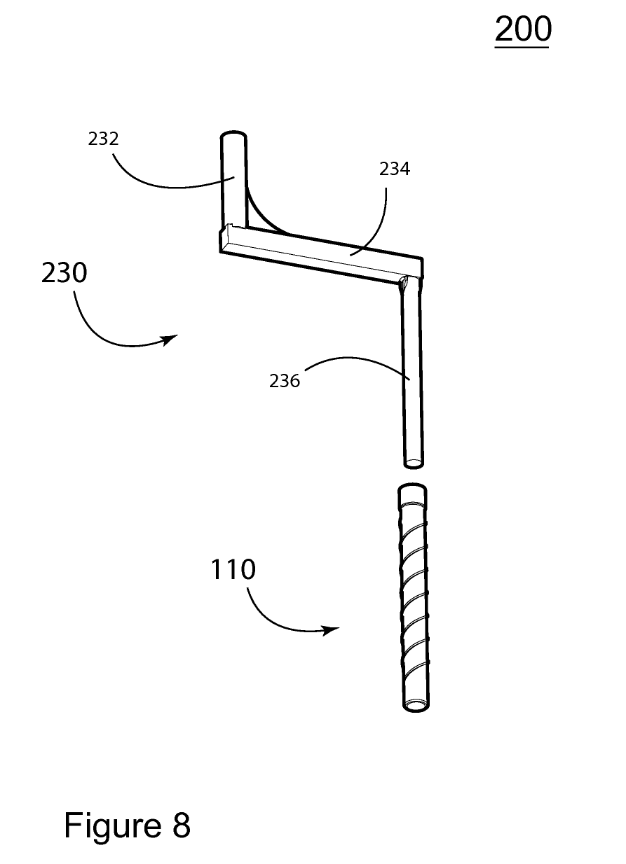

FIG. 8 200 is an exploded view of the second iteration, with no pole. The optional, pivoting cantilevered extending arm 230 is inserted into the elongate tube 110. The cantilevered extending arm has a vertical support 236, a horizontal support 234, and a hollow receptacle 232 into which any pole (not shown) can be placed.

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

1. A property-boundary marker that can be inserted into the ground comprising:
an elongate tube that can receive any vertical elongated elements;
an installing rod that engages with the elongate tube to screw it into the ground;
and a cap that engages with the top of the elongate tube which keeps out debris when nothing is inserted in the tube.

2. The elongate tube of claim 1 comprising an outer surface, an inner surface and a screw-thread on the outer surface to assist in the insertion of the elongate tube into the ground.

3. The cap of claim one further comprising an engagement means between the cap and installer, in which the installer, which has at least 2 protrusions, engages axially with the cap, which has at least 2 corresponding holes, allowing the installer to be used to turn the cap radially until the cap is screwed into the top of the elongate tube.

4. The property-boundary marker of claim 1 with a cantilevered extending arm that engages with the elongate tube.
